(19) United States
(12) Patent Application Publication
(10) Pub. No.: US 2005/0027544 A1
(43) Pub. Date: Feb. 3, 2005

(54) Document generation and workflow process and apparatus

(76) Inventors: Paul Newstead, Loveland, OH (US); Terry Whiter, Charvil (GB)

Correspondence Address: DANIEL B. RUNK, 1400 PROVIDENT TOWER, ONE EAST FOURTH STREET, CINCINNATI, OH, 45202, US

(21) Appl. No.: 10/628,940

(22) Filed: Jul. 28, 2003

(51) Int. Cl. G06F 17/60

(52) U.S. Cl. 705/1

(57) ABSTRACT

A document generation and workflow process in which documents are designed as templates with an inherent logic that can have multiple dependencies and defined security levels for varying authorizations. After design, the documents are used by authorized users to generate one-off correspondence for customers which is then placed in a queue. From the queue, the generated document can be sent along a workflow process in which a supervisor reviews and edits the document or can be sent to the customer. Either before or after sending, the document can be archived and any databases required for variable data may be updated.

### FIELD OF INVENTION

This invention relates generally to the fields of workflow processes, document generation and information distribution and recordation, and more specifically, to systems and processes enabling the user to create customized documents for its customers on a “one-off” basis.

### BACKGROUND OF THE INVENTION

Document generation systems are designed to permit generation of documents, typically for large customer groups, more quickly than they can be generated individually. Traditionally this involves having data supplied from a large database into template fields within a predefined document. For instance, a company may decide to mail an advertisement letter to customers by creating a letter and specifying that the name and address fields are supplied by the database and then merging the body of the letter with the address database. A company may even enter customized data within the body of the letter, such as entering a name or location of customer to make the letter appear more customized for the customer. This enables quick production of correspondence for large groups.

Companies may also attempt to generate correspondence with their customers by having employees generate correspondence one letter at a time, either as original correspondence or by using templates; however, this is time consuming and inefficient unless the form of correspondence to each recipient is very similar.

Other customized document generation systems exist, but they typically use predetermined, static sections of text or include or omit sections based only on pre-defined database fields that restrict the ability of the document generator to create “one-off” documents that are truly personalized and tailored for a particular customer.

Thus a need exists for a document generation system and workflow that permits a document generating entity to create easily customizable “one-off” documents in a quick and efficient manner by combining aspects of individual document control with automatic mass document generation.

### SUMMARY OF THE INVENTION

The present invention is a document generation system that permits the design, definition, access, generation, review, sending and recordation of documents. In the design step, the document layouts are designed for the system users and sections of the documents are defined and the inherent logic of the document is established. The layouts include predefined text sections, dependent sections and user selected sections (potentially including ad hoc personalized sections). The inherent document logic permits selection or rejection of certain sections, either by user selection or user or database entered variables. The generation process even permits “predefined” sections of text to be logically linked to variable data from third party software or data. In the security step, documents or sections of documents are defined to control the ability of specific users to access a document, modify a particular section thereof or review the generated work product. The security levels can also be set to detect third party software security levels, such as the status of user logins, to avoid requiring individual users logging into the system.

The system itself can be operated either in a client/server or web-based environment by using the supplied application program interface (API). The API also serves to permit interfacing with third party products that may supply data to the system. After gaining access to the system, the user commences document generation by selecting an information key which determines how the document session will begin. The information key could be the type of document or the type of information to be used, such as a customer name. After selecting the information key and selecting a particular document, the user begins the document generation phase by using the inherent logic to create a document, including selecting relevant sections, if applicable, or adding or editing content as otherwise necessary. This process can include automatically supplying the system with third party data which can affect the document structure based on the inherent logic defined in the document design process. Upon completion of the document construction, the user can append the appropriate authorized signature for the correspondence and review the document with a spelling or grammar checker as part of the generation process.

A complete document is then sent through a workflow process to be reviewed, edited if necessary, recorded and sent to the intended recipient. The document may be routed to an authorized party for review, if necessary. Upon approval, if necessary, the document can be sent to the intended recipient by a variety of means such as e-mail, fax or mail, either as selected by the user or as predetermined during the document definition.

At any time after generation, review, being edited or sent, the correspondence can be saved in a correspondence database or file along with other information pertaining to the document, either automatically as defined during the document definition or at a user's discretion.

The present invention has many advantages for users, user's supervisors and correspondence recipients. One advantage is that the system and process permit increased personalization of correspondence since forms generated are individually tailored for specific customers. Another advantage is that the documents generated are more likely to be final work product than those produced with existing systems, since the documents are capable of greater customization within a standardized framework. Further, the more rapid generation increases user productivity and thereby also accelerates document turnaround to customers. Another advantage is that the documents are sent out after review as opposed to batch jobs that require printing and processing prior to sending, thereby avoiding potentially untimely correspondence. Another advantage is that much user editing is automated with the improved system and process, thereby necessitating fewer changes and more uniform documents. Further, since the system selects the appropriate document and attachment, the correct form is automatically chosen and user error is avoided. Another advantage is that the workflow security ensures that documents requiring review are reviewed by the appropriate party prior to being sent and restricts users from sending unauthorized correspondence.

### BRIEF DESCRIPTION OF THE DRAWINGS

FIG. 1 is a screen capture showing the document modeling directory.

FIGS. 2-9 are screen captures showing the correspondence modeling administrator.

FIGS. 10 are screen captures showing the user definition.

FIGS. 11-13 are screen captures showing the correspondence security dialog module.

FIGS. 14-25 are screen captures showing web based document generation and editing using the web document services program.

FIG. 26A is a flowchart showing the design process for generating the document and 26B shows the implementation for a particular scenario.

FIG. 27A is a flowchart showing the process for defining security levels and users for the documents and 27B shows the implementation for a particular scenario.

FIG. 28A is a flowchart showing the process of logging into the system and generating the document and 28B shows the implementation for a particular scenario.

FIG. 29A is a flowchart showing the process for the document generation dependencies and 29B shows the implementation for a particular scenario.

FIG. 30A is a flowchart showing the process for reviewing the document and creating output for the document and FIG. 30B shows the implementation for a particular scenario.

### DETAILED DESCRIPTION OF THE DRAWINGS

This invention relates to a document generation process and workflow in which documents are designed with pre-determined inherent logic to permit generation of one-off correspondence by users for customers.

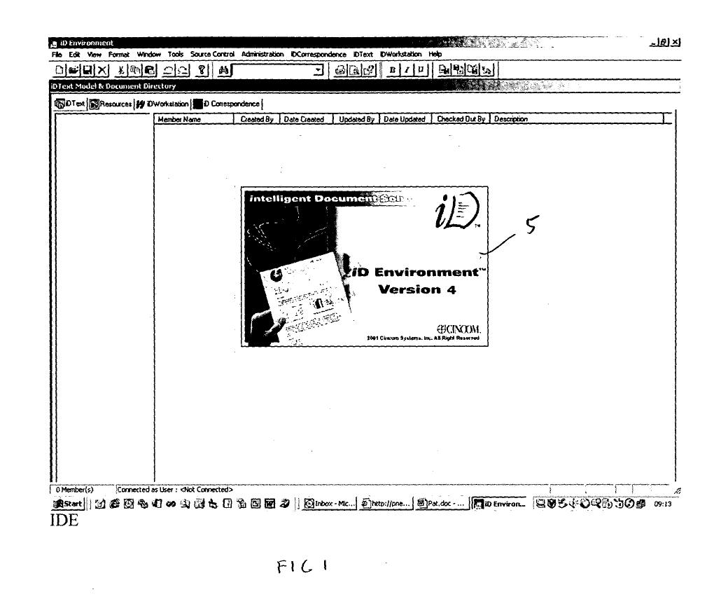

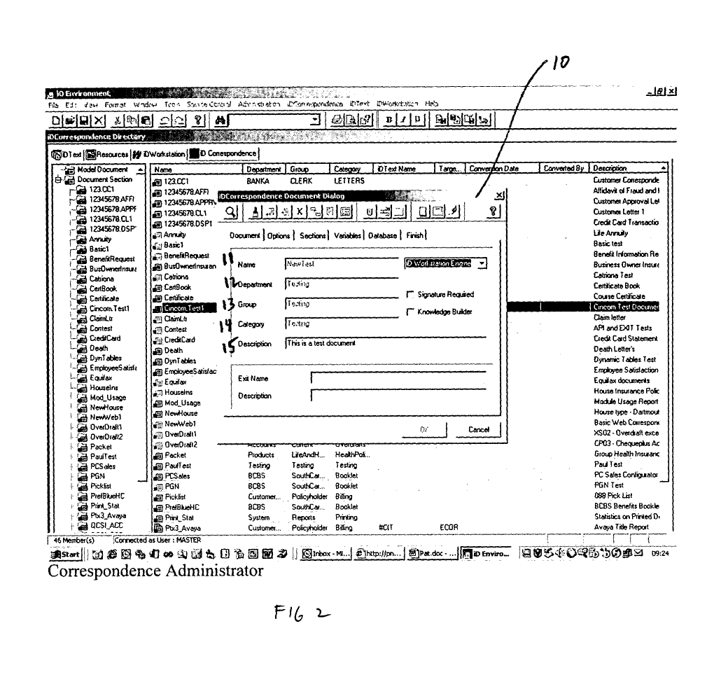

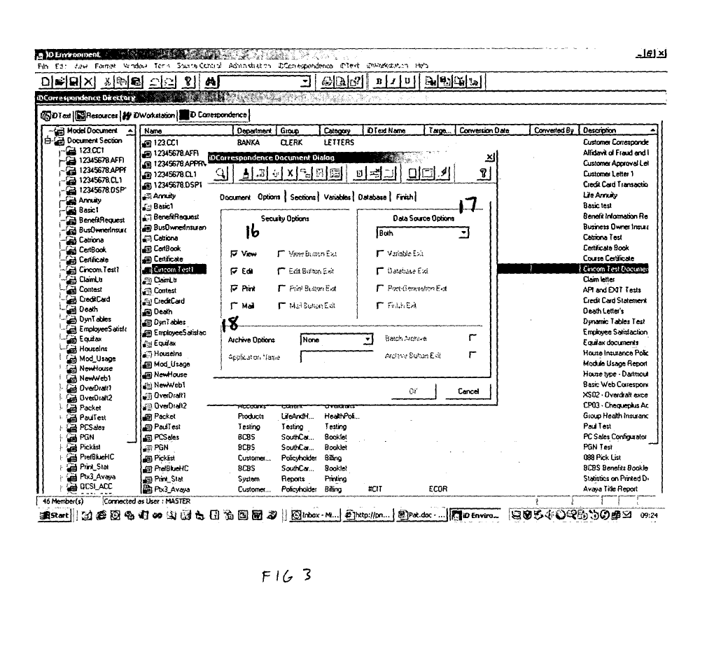

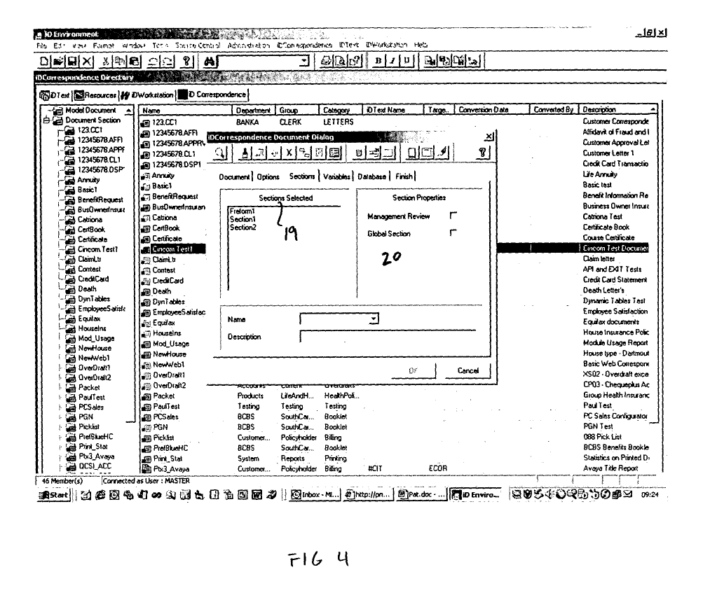

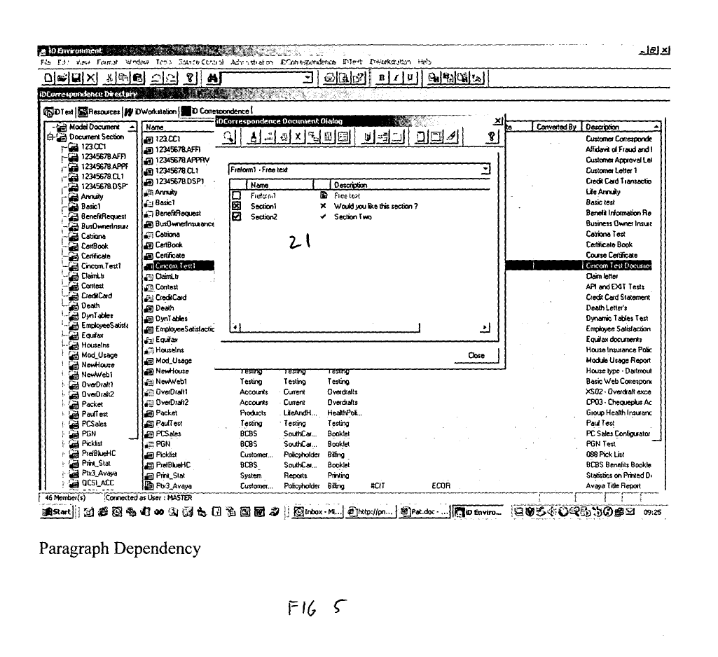

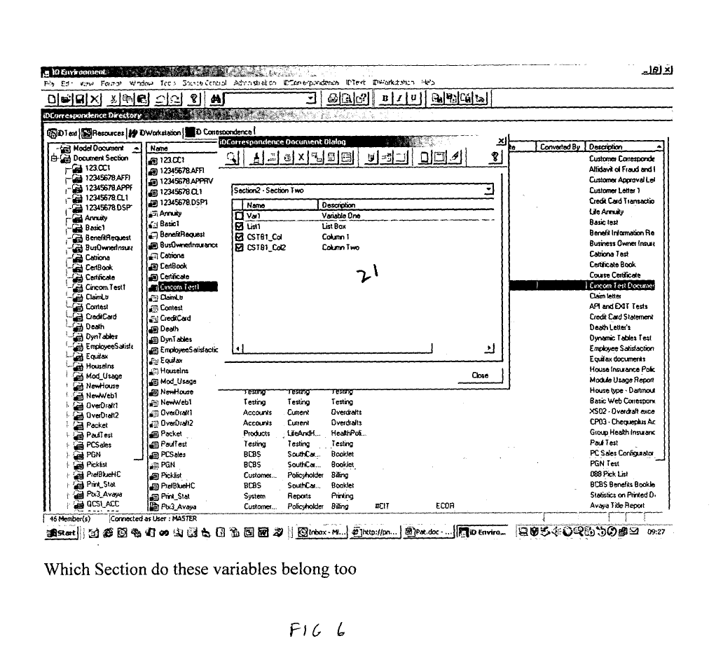

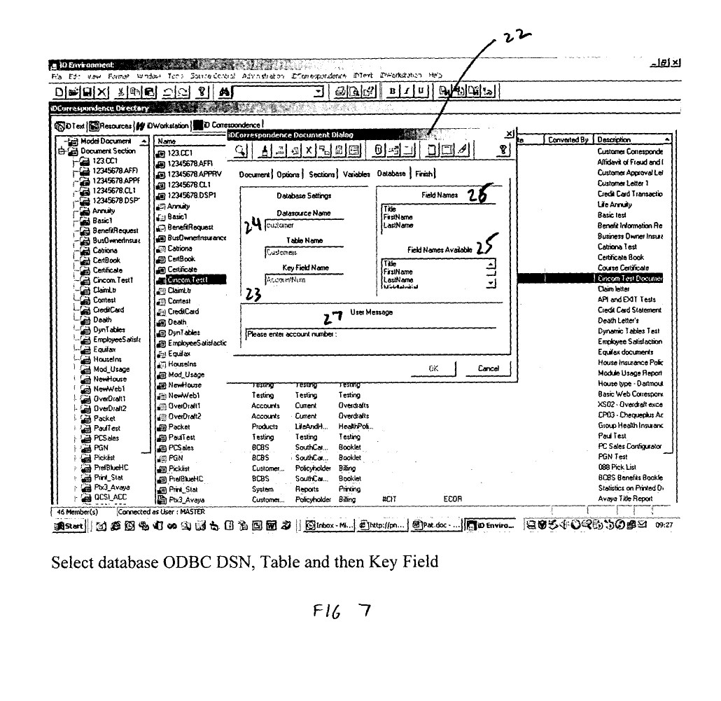

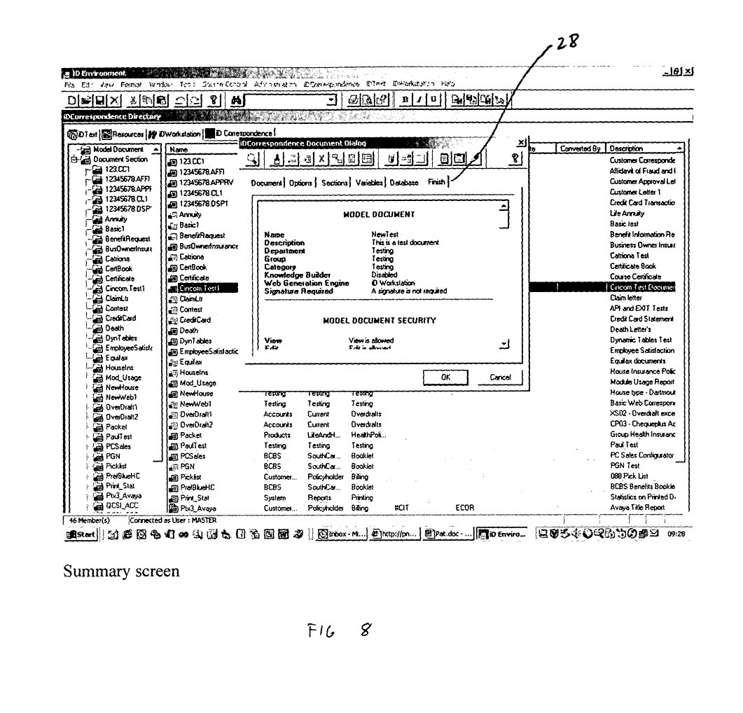

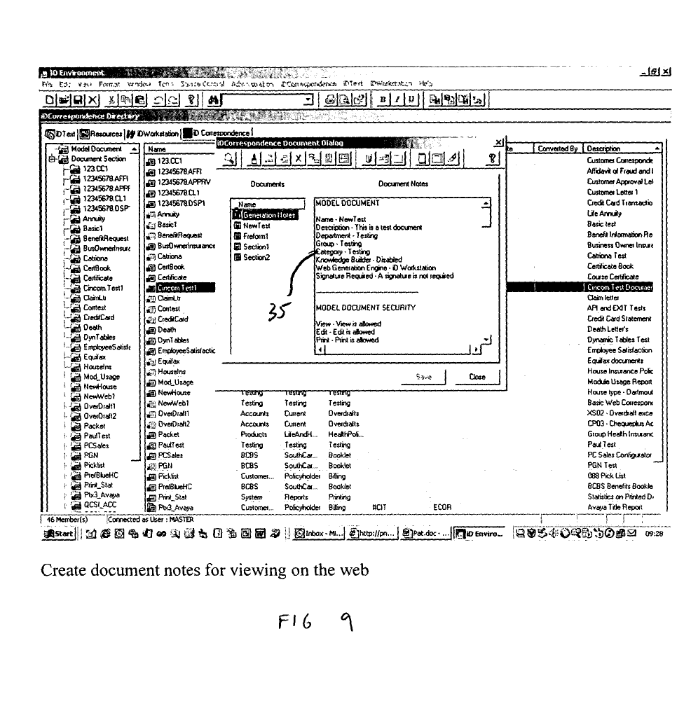

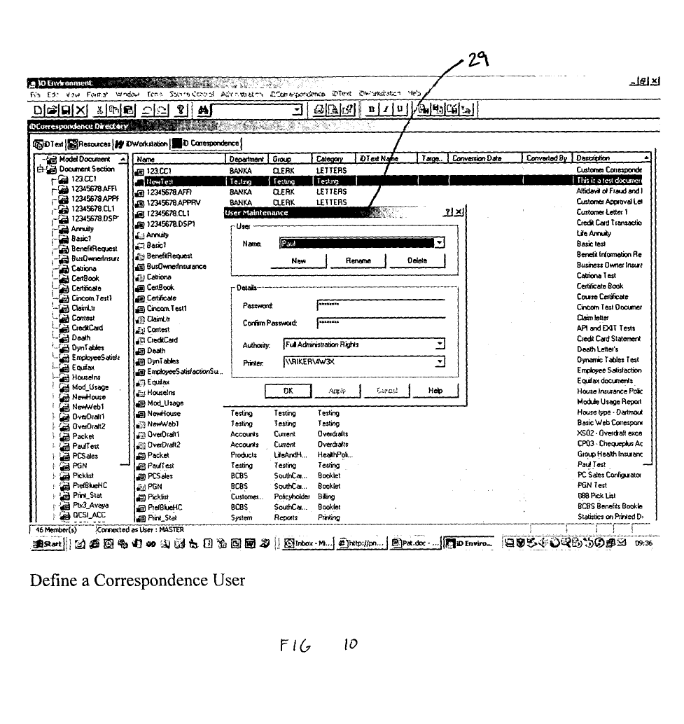

As depicted in FIGS. 1-10, the document 1 is generated by the user via the generation module 5. After logging into the generation module 5 the designer is presented with a correspondence administrator definition interface 10 that permits the designer to define the document name 11, department 12, group 13, category 14 and description 15. The correspondence administrator interface 10 permits the creation of specific document classes for use within specific divisions of a company. The correspondence administrator interface 10 also permits definition of security options 16, data source options 17 and archive options 18. The security options 16 define what a user of the system may do to the document 1 being designed, such as accessing, viewing, editing, printing and/or sending the document 1. The data source options 17 determine what data sources may be made available to the document 1, such as variable data, third party data or data input by a user. The correspondence administrator interface 10 then permits the designer to define the actual sections 19 of the document 1 and control attributes for those sections 19, including defining whether the section will be global and whether management review will be required. The dependencies, if any, of the sections 19 are then defined in the variables options 20 portion of the interface 10. As the sections 19 are individually selected, the section can be defined. Examples of the sections are free text sections to be created by the user, an independent section that stands alone or a dependent section. After the sections 19 are set up, any necessary database variables 21 are defined. The file or program database from which the data is pulled is defined as seen in 22 and a key field 23 is defined as the principle information field by which the database 24 is queried on an individual basis. The interface 10 determines the available field names 25 and the desired fields 26 are selected by the designer for inclusion in the document 1. A prompt 27 is also set up for the key field 23 so the user knows what information should be used to search the database 24, such as an account number. After the interface steps are complete a summary 28 is presented to the designer for confirmation that the document definitions are correct. The designer may easily revise any aspect of the definitions of the document 1 by selecting the appropriate tab of the generation module 5. After the designer confirms that the document definitions are correct, the designer is prompted to enter document notes 35 to permit other designers to understand more easily the logic in the document 1 and act as a help section to assist users with their use of the document 1.

The documents 1 described in the preceding paragraph can have varying degrees of inherent logic ranging from no dependencies to documents with all types of variables. The simplest document 1 would be one with no dependencies that consisted simply of a set text form with the only variable information being the customer information, such as name and address. A more complicated form would have free text sections for completion by the user, variable data for the customer information within defined sections, other variable data for the document directed from the company's databases to defined sections, other variable data for the document directed from third party databases to defined sections, contingent text and variable data that is conditional based on whether other sections are selected either by the user or automatically through defined logic, and attachable forms that are attached either at the user's election or on a variable basis depending upon whether other sections are included by the user.

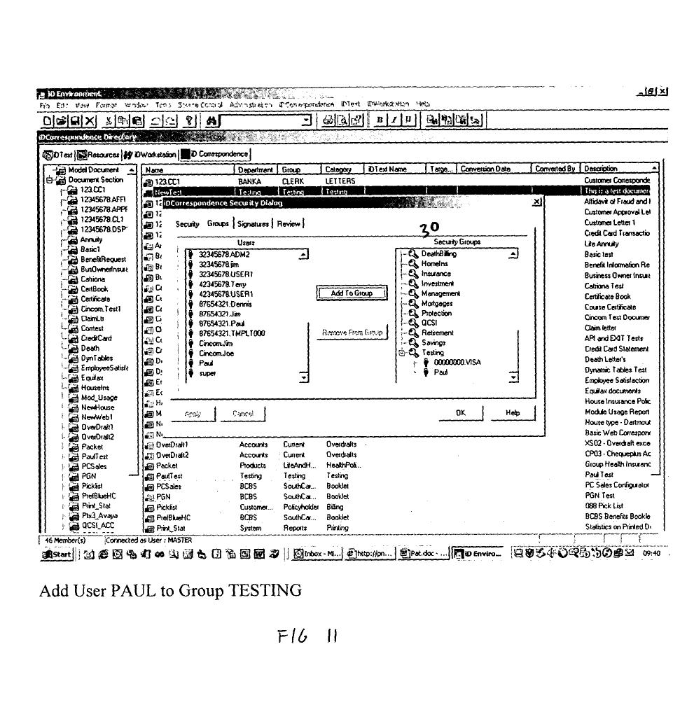

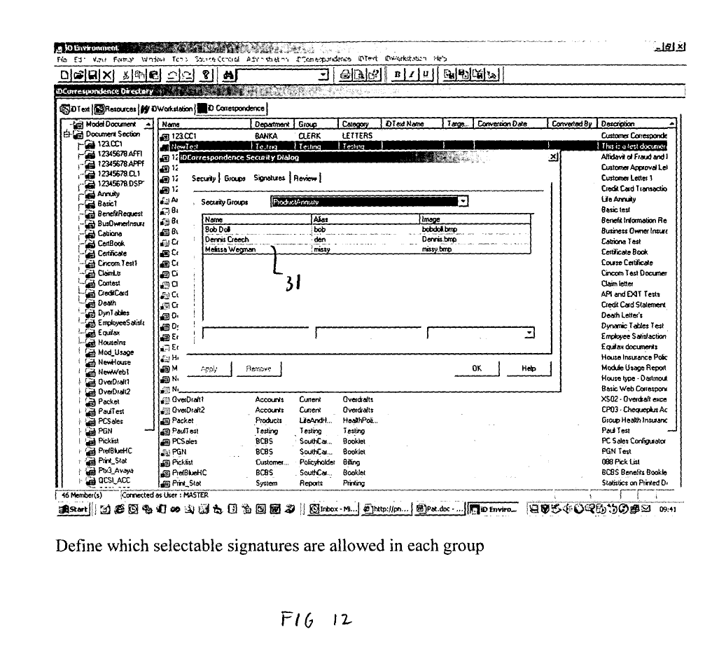

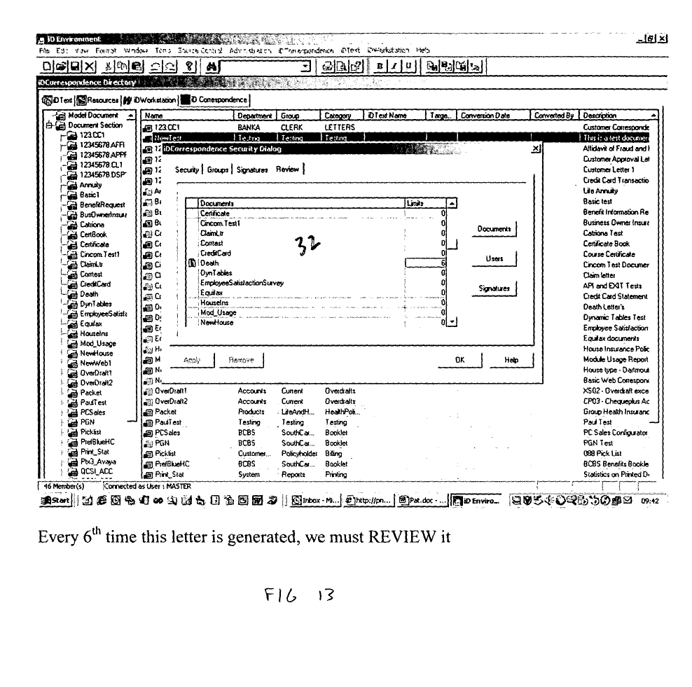

As depicted in FIGS. 11-13, after a document 1 is defined using the module 5, the designer uses the security interface 29 to define the correspondence users for the documents 1 as well as the scope of authority granted to each user, or class of user, and the designer defines the output destination for the prepared documents 1 of such users. Once defined, the users are added to groups 30 that are authorized to access the documents 1. One way of defining the groups 30 is by the particular classes of documents, such as department 12, group 13 or category 14. Each group 30 has designated individuals whom the users can select as the signatory 31 for a document 1 within the documents available to that group 30. An image of the signature of the signatories 31 can also be linked to the group documents 1 to permit automated signing of the correspondence. The security interface also defines the appropriate review standards 32 for the documents 1 in the group 30, such requiring review of every document, every fifth document or no review at all.

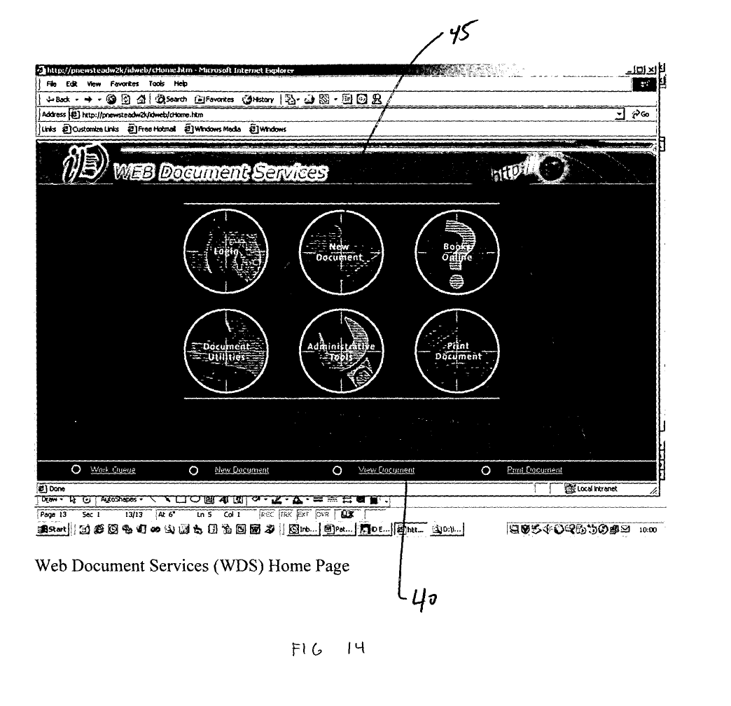

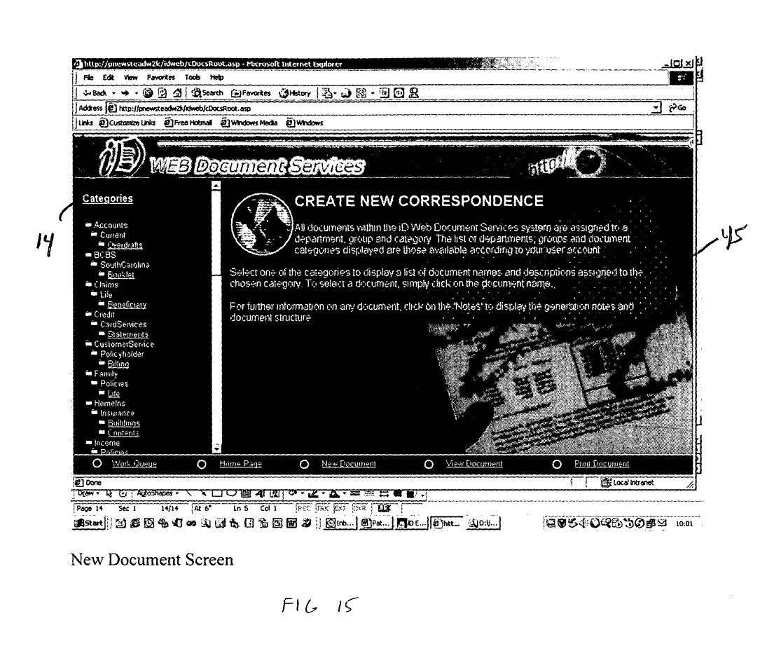

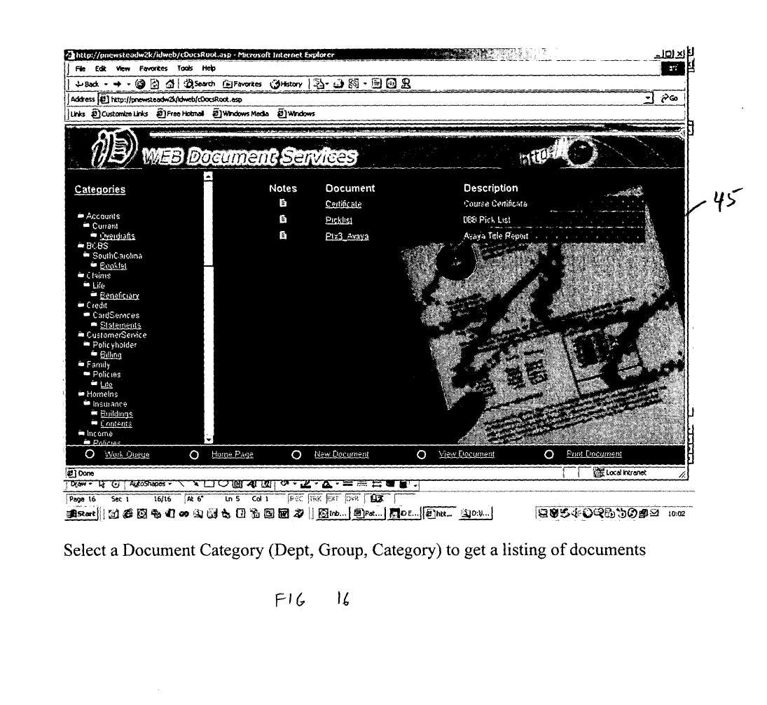

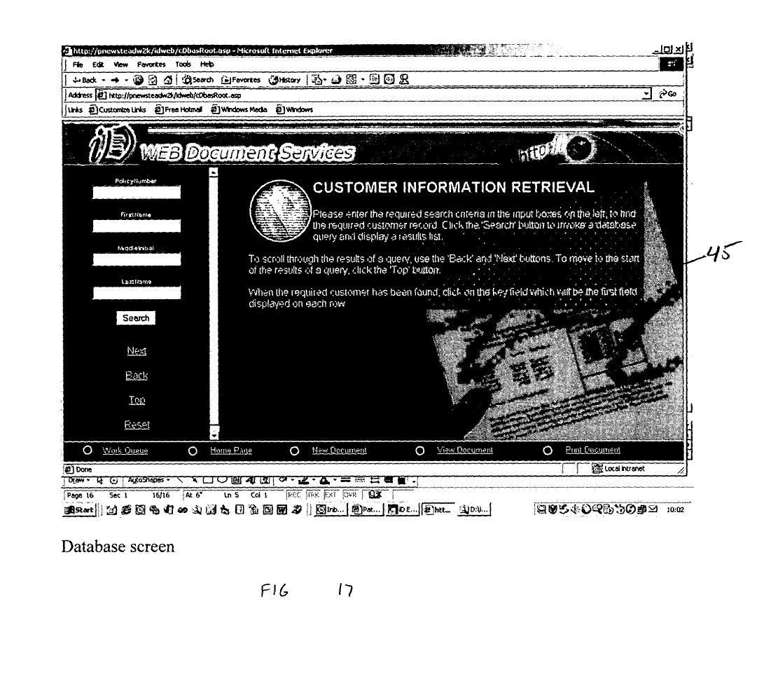

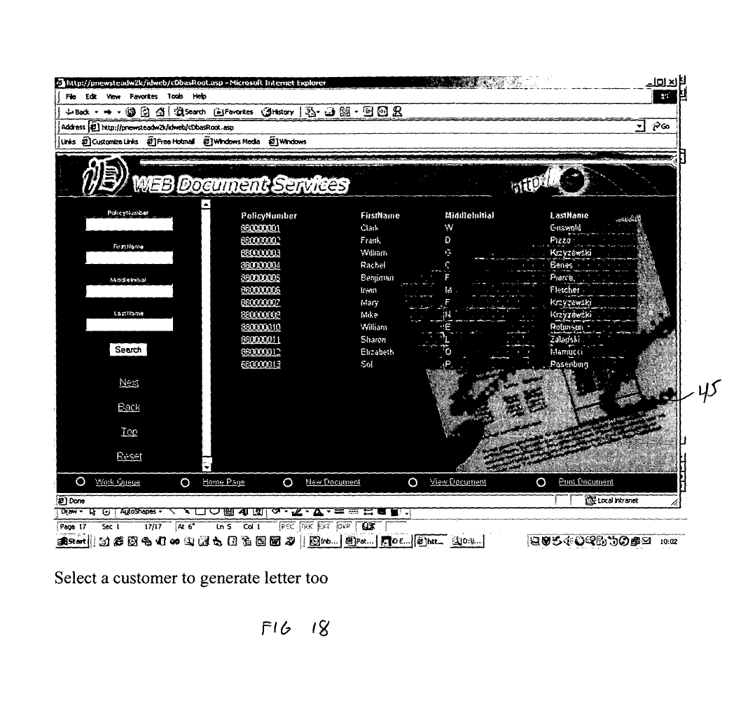

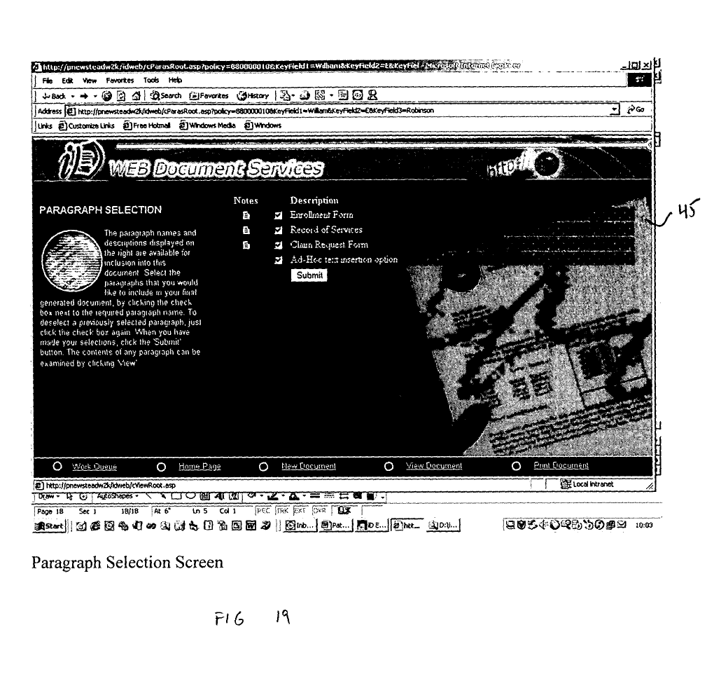

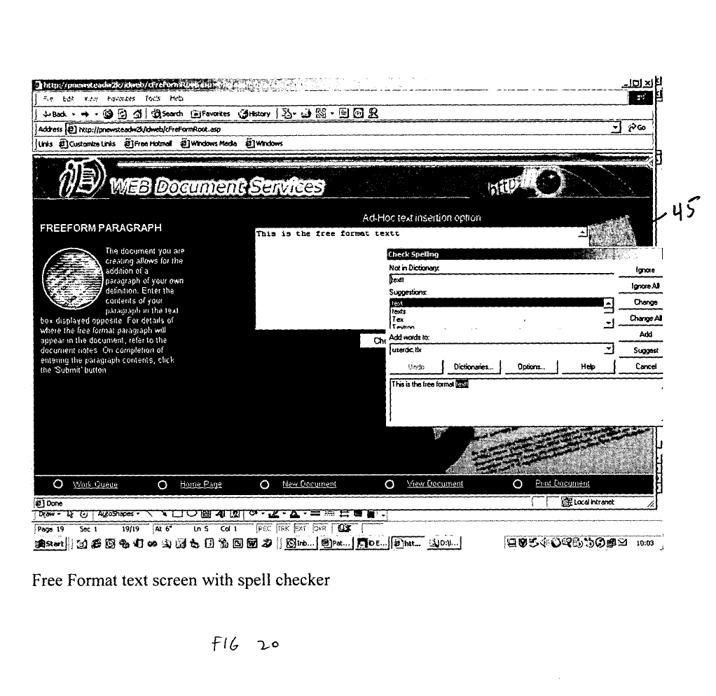

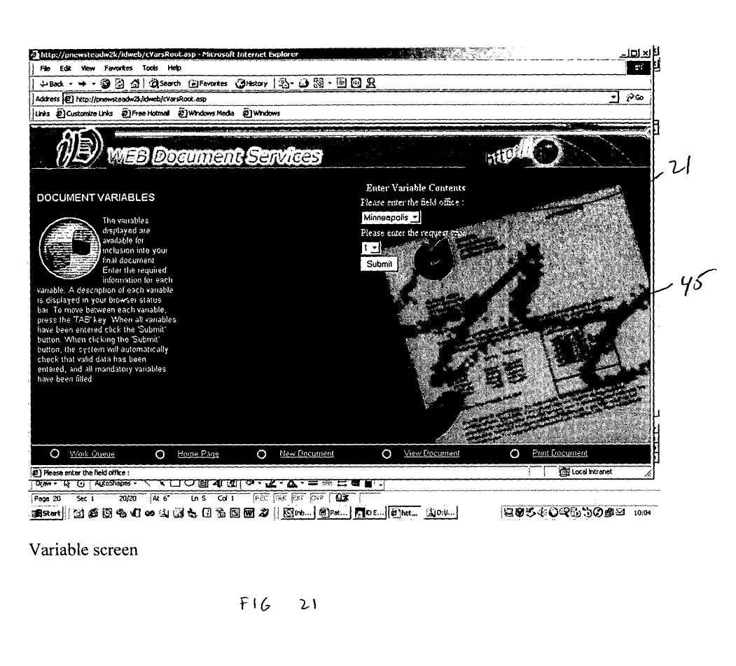

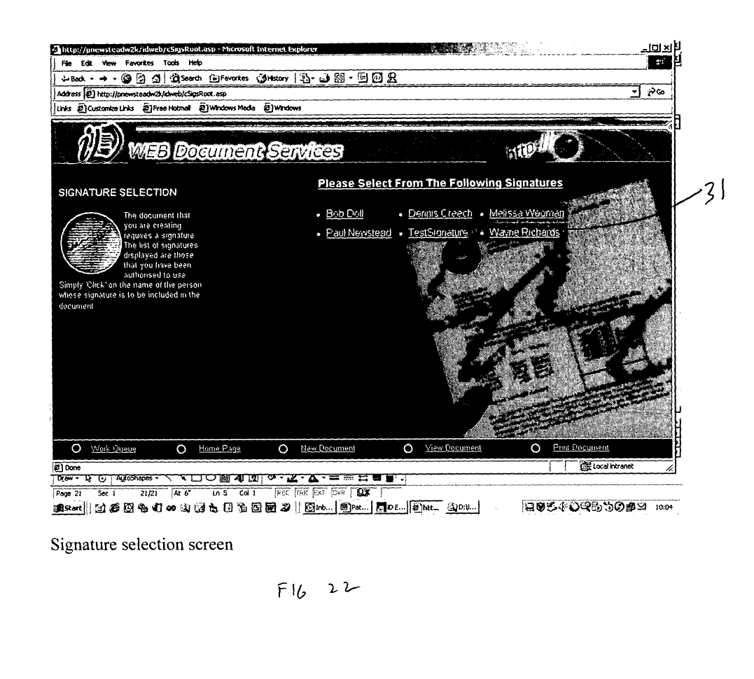

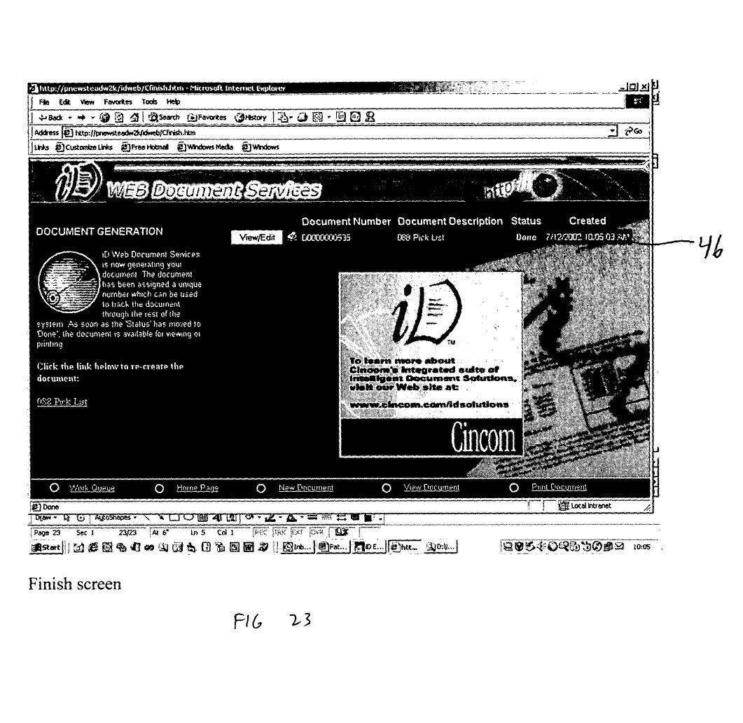

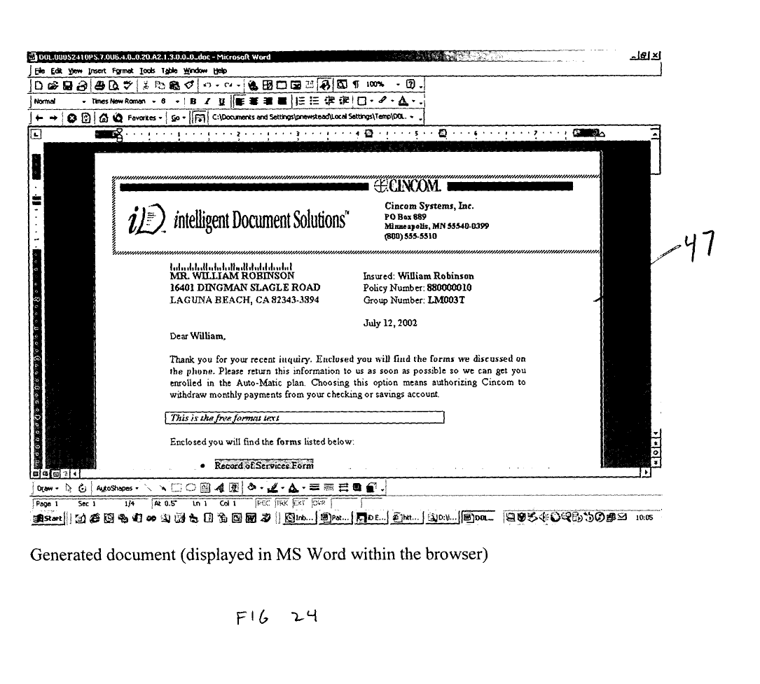

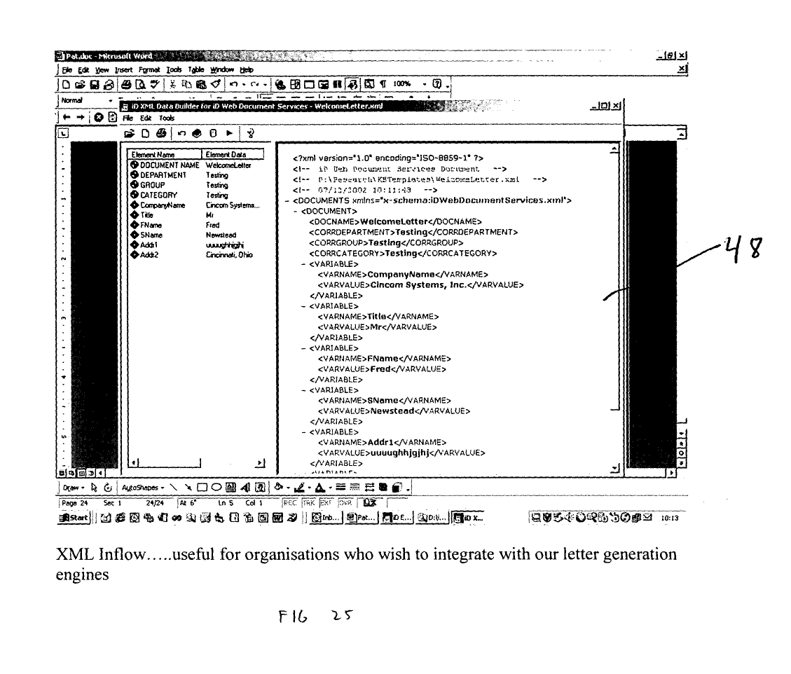

The document 1 generated with the generation module 5 and further defined by the security interface 29 can be accessed either in a web service provider environment or a networked server-client environment as shown in FIGS. 14-25. Regardless of the hosting environment, the user must login or enter the document services home page 40. In a preferred embodiment, the user is automatically logged into the system based on the user's previous login into the client computer. A number of utilities and help documents may be made available at the home page 40, but the primary initial function by a user is the generation of a new document. The document 1 to be generated is selected using an information key that can be the document information or customer related information. If selecting the document 1 by document information, the user can select a department 12, group 13 or category 14 for a listing of documents 1. If selecting the document 1 by customer related information, the production module 45 prompts the user for customer information, which can be a surname, address, social security number, policy number or other personal identification information. In the preferred embodiment, the production module user is supplied with data from which to select the end customer from a customer database. Once the document 1 and individual customer have been selected, the production module 45 prompts the user to select the components of the document 1 to be included in the correspondence to the customer based on the document definitions. Any variables 21 programmed into the document 1 during the document design process are either automatically filled from the source defined during the design process or are completed by the user via prompting from the production module 45. After the document 1 is completed by the user, one of the signatures of the authorized signatories is attached and the document 1 is placed in a queue 46. From the queue 46, the document can be reviewed, edited, printed and/or sent by a user or forwarded to a supervisor for review, editing, printing and/or sending based on the characteristics defined during the document design process. The queued document 46 can be viewed, edited or printed through an existing word processing program 47 such as Microsoft Word or converted into XML for customized use by users in their own computer applications 48.

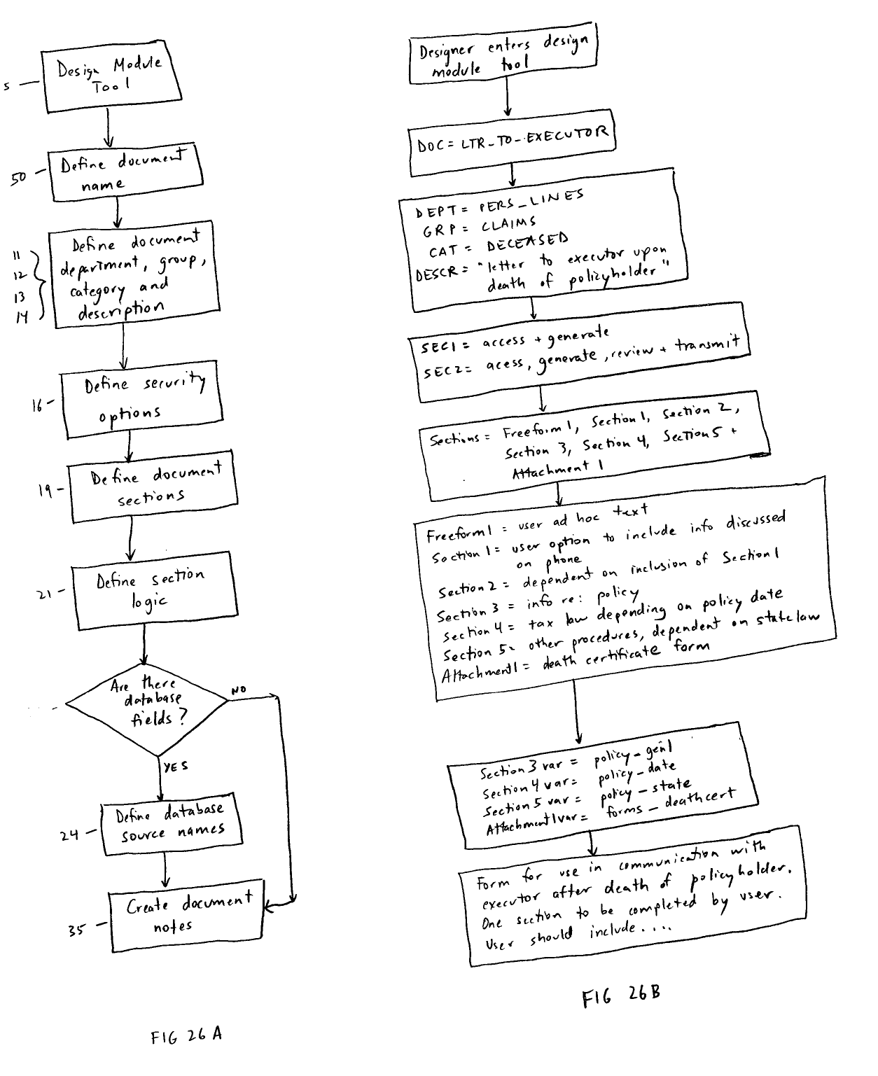

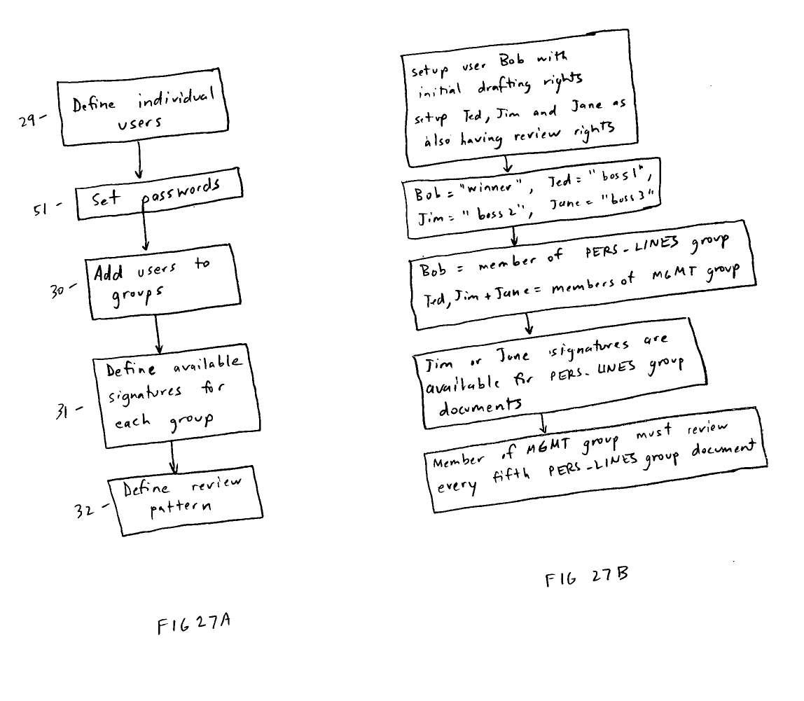

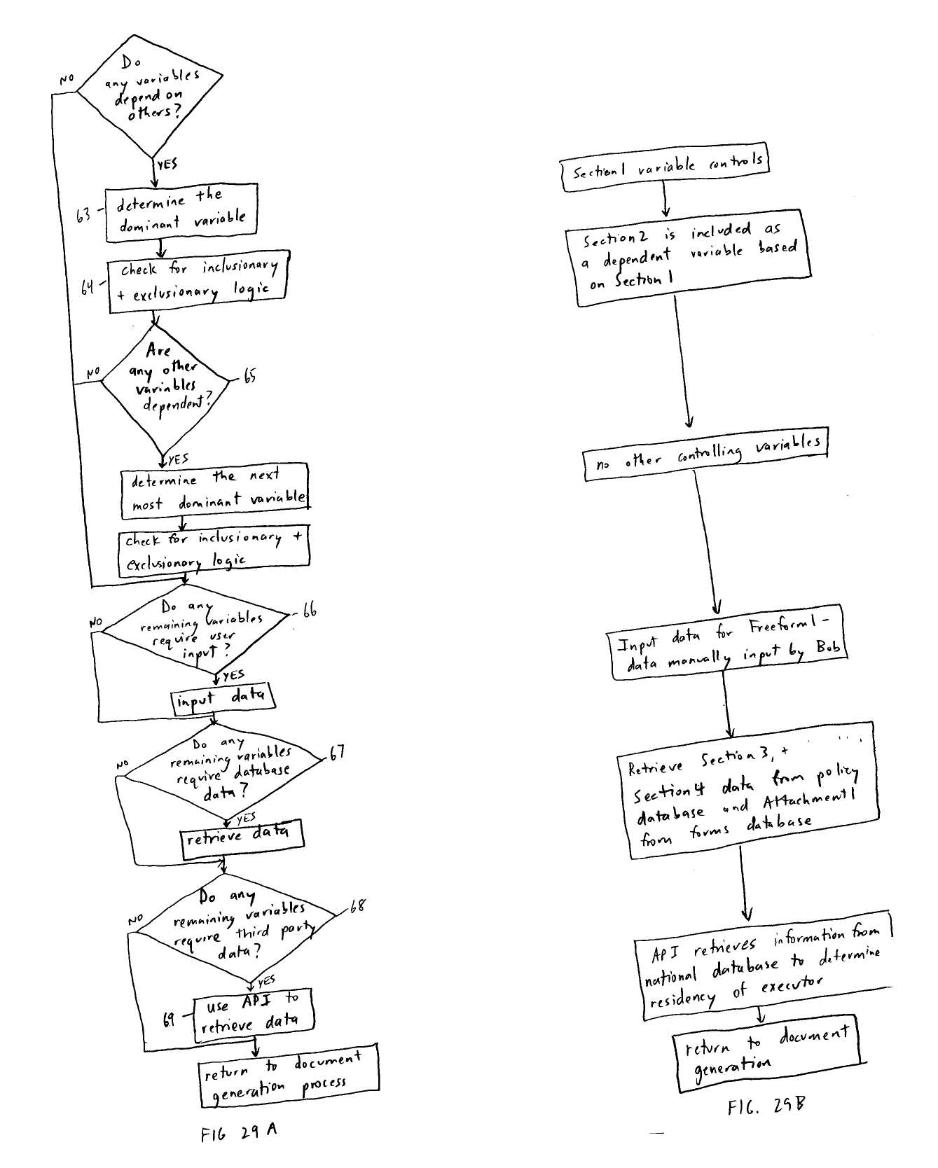

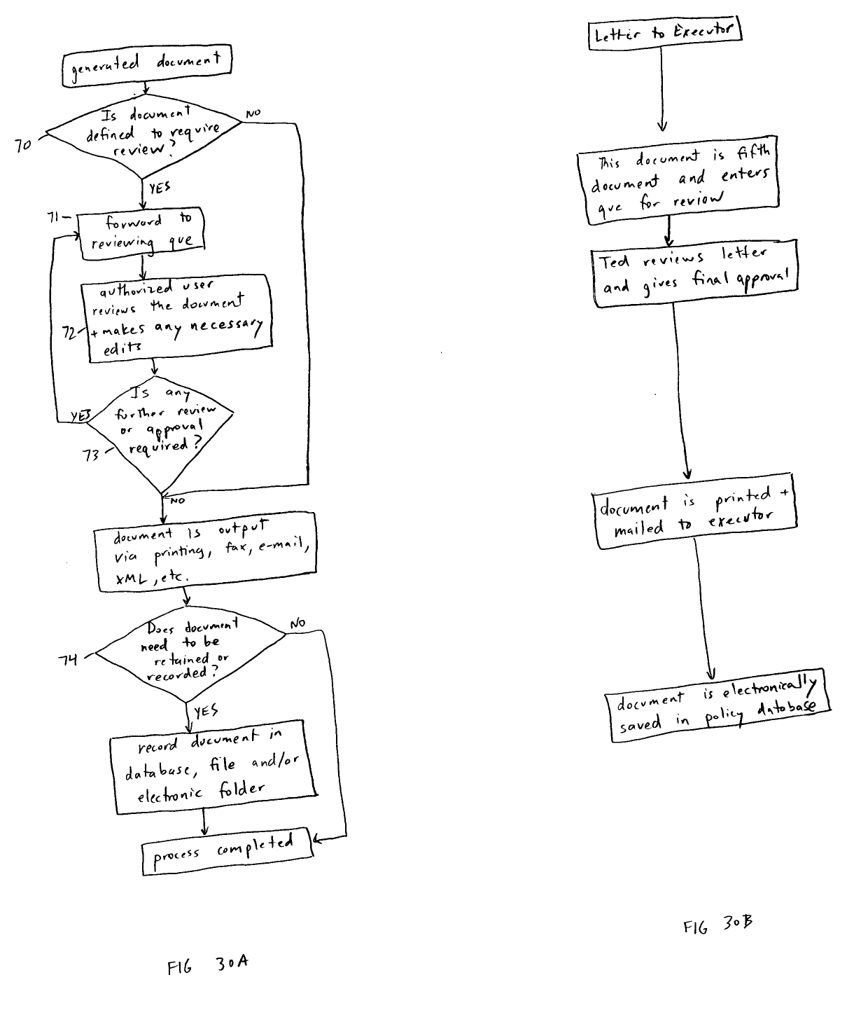

FIGS. 26A-30A show the process described above in and FIGS. 26B-30B follow an example from the definition of a document to its final sending. In the sample transaction a document is created to be sent to the executor of an estate and users, Bob and Ted, generate and send out the correspondence.

The process begins by using the design module tool. The designer names 50 the document, LTR_TO_EXECUTOR and defines the department 11 (PERS_LINES), group 12 (CLAIMS), category 13 (DECEASED) and description 14 (“letter to be sent to the executor upon the death of the policyholder”). The designer then designs the security options 16 as two levels, SEC1 with which users can access, generate and edit the document and SEC2 with which users can perform the SEC1 functions as well as review, approve and transmit the document. Next the designer defines the sections 19 of the document as Freeform1, Section 1, Section 2, Section 3, Section 4, Section 5 and Attachment 1. The logic 21 and data sources 24 are then defined for each section 19. Freeform1 is defined as a section of text to be input by a user (if desired), Section 1 is a variable section that the user will include if he spoke on the phone with the executor, Section 2 is a section describing the details of a payment plan which is dependent on the inclusion of Section 2, Section 3 is a standard paragraph included in all versions of the document describing the policy of the deceased, Section 4 refers to the database of the company to determine the date of the policy and inclusion is dependent on the date of the policy, Section 5 is defined to be included if the executor is a resident of California and additional specific procedures apply and Attachment1 is defined to be a death certificate certification form required by the company prior to releasing funds from the policy. The database fields 24 are defined for Section 4 and Section 5 as well as the standard address information for the executor. The designer then completes the design process by creating design notes 35 for the document.

After the document is designed the designer also sets up the system users 29 and defines their passwords 51. In this case, Bob is setup as an initial drafter with SEC1 authority and Ted, Jim and Jane are given SEC2 authority. All four users are added to the Personal Lines Group. Jim and Jane are designated as authorized signatories 31 for the executor letter. The review pattern for the letter 32 is then defined as requiring a SEC2 user to review and approve every fifth letter generated by a SEC1 user.

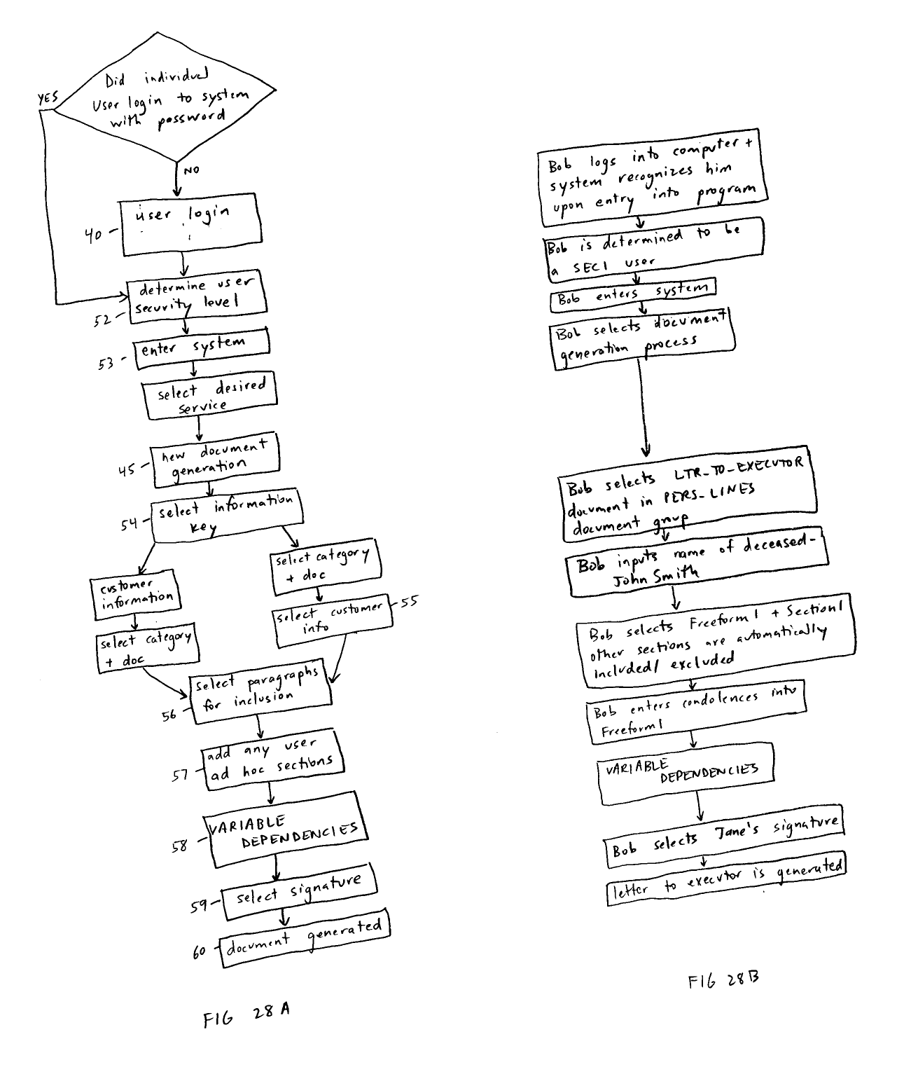

With the executor letter and users being defined, the user, Bob, enters the system 40 without using his password since he is on a computer on which he has already logged in and the system recognizes him and logs him in with SEC1 authority 52. After entering the system 53. Bob selects the new document generation service 45 and under the CLAIMS group selects information key 54 which in this case is the LTR_TO_EXECUTOR document to be generated. Bob selects the deceased's name 55, John Smith, and elects to include Freeform1 and Section1 sections 56. All of the other fields are automatically incorporated or excluded based on the document logic. In the Freeform1 section Bob types his condolences 57 based on the conversation he had with the executor since the deceased was the executor's father. The rest of the document is automatically generated using the dependencies 58 defined in the document via the process set forth on FIGS. 28A and 28B. Bob selects Jane as the signatory 59 for the letter and is completed with the document generation 60.

If the document has multiple variables 61 like the executor letter, the system checks to see if the variables depend on each other 62. If they do, the system determines the primary variable 63 and then determines whether that variable requires any inclusions or exclusions from the remainder of the document. The system reads that Section1 is a controlling variable and by being included in the document it also requires that Section2 be included and it does not require any exclusion. If any other variables are controlling, then the system performs those inclusions and exclusions 65. Since none of the other variables in the executor letter are controlling other sections the system then determines whether the remaining variables require user input 66, client data 67 or third party data 68 and the system retrieves the data 69. The user input data is the Freeform1 data that Bob typed into the document and the document automatically queries the company's database for the policy amount and the application program interface queries a national database for the executor's address to determine whether Section4 and Section5 should be included in the document.

After the document generation is completed by Bob the system determines whether it requires review 70. If not, the document is sent out and recorded. If it is the fifth document that was generated by a SEC1 user then it is forwarded to a queue 71 and a SEC2 authorized user such as Ted must review the document 72. If further approval is required 73 then steps 71 and 72 are repeated, otherwise the document is output by printing and delivery, faxing, e-mailing or transfer into another data format of the company such as XML. If the correspondence needs to be saved 74, then it is directed to a database, file or electronic file based on the document definitions.

The preceding description of the invention has shown and described certain embodiments thereof; however, it is intended by way of illustration and example only and not by way of limitation. Those skilled in the art should understand that various changes, omissions and additions may be made to the invention without departing from the spirit and scope of the invention.

1. A process for generating correspondence documents customized for the recipient, the process comprising:
designing one or more document templates by defining certain static and variable sections;
defining security levels for accessing and generating said documents and for reviewing and sending out said documents;
defining one or more users;
making said documents available to users;
determining security level authorizations for said users;
having said user select an information key; and
generating said document.

2. The process of claim 1 wherein said process further includes the step of forwarding said document along a workflow routing defined in said designing step.

3. The process of claim 2 wherein said process further includes the step of sending said document to a recipient.

4. The process of claim 3 wherein said sections are one or more of the following: user ad hoc input sections, static sections and variable sections dependent based upon inherent logic defined in said designing step or sections dependent on user input.

5. The process of claim 3 wherein said process further includes the step of archiving said document and updating any of said databases from which data was provided for said document.

6. The process of claim 3 wherein said having and generating steps are made available to users via the Internet.

7. The process of claim 3 wherein said having and generating steps are made available to users using client computers receiving data from a server.

8. The process of claim 3 wherein said security level authorizations are provided from third party software which said users have used to log in to their computers.

9. The process of claim 8 wherein said generating step further comprises exporting the document data results in XML.

10. The process of claim 4 wherein said variable sections are dependent on data supplied to the process from a third party data source.

11. The process of claim 3 wherein said information key is a document type or customer identification information.

12. The process of claim 2 wherein said process also includes the steps of reviewing and sending the generated document.

13. A computer-readable medium containing instructions for controlling a computer system to generate document correspondence customized to the final recipient, by a method comprising:
designing one or more document templates by defining certain static and variable sections;
defining security levels for accessing and generating said documents and for reviewing and sending out said documents;
defining one or more users;
making said documents available to users;
determining security level authorizations for said users;
having said user select an information key; and
generating said document.

14. An apparatus for generating document correspondence customized to the final recipient, the apparatus comprising:
means for designing the document templates by defining certain static and variable sections and defining security levels for said documents and for said sections within said documents;
means for storing said designed documents means for determining the security level authorizations for said end users;
means for making said designed documents available to end users based on said security level authorizations within a grouping of said documents;
means for generating, reviewing and sending said document.

15. The apparatus of claim 14 wherein said grouping of said documents is a software program that controls the format and access to said documents.

16. The apparatus of claim 14 wherein said means for storing said documents is a server computer and said means for making said designed documents available to end users is a client computer that receives said documents from said server computer.

17. The apparatus of claim 14 wherein said means for storing said documents is a server computer and said means for making said designed documents available to end users is a web browser client that receives said documents from said server computer.

18. The apparatus of claim 14 wherein said means for determining the security level clearances for said end users is a security access code input by said end user.

19. The apparatus of claim 15 wherein said means for determining the security level clearances for said end users is a security access code provided to said software program from the security level of a third party software program.

20. The apparatus of claim 14 wherein said means for sending said document include one of the following group: mail service, facsimile or electronic mail.
